(19) United States
(12) Patent Application Publication
(10) Pub. No.: US 2024/0402677 A1
(43) Pub. Date: Dec. 5, 2024

(54) DEVICE MANAGEMENT SYSTEM, INDICATION MAINTENANCE SYSTEM, DEVICE MANAGEMENT METHOD, AND RECORDING MEDIUM

(71) Applicant: NEC Corporation, Minato-ku, Tokyo (JP)

(72) Inventors: Yoji MORI, Tokyo (JP); Yoshiyuki Etou, Tokyo (JP); Daisuke Matsuda, Tokyo (JP)

(73) Assignee: NEC Corporation, Minato-ku, Tokyo (JP)

(21) Appl. No.: 18/690,292

(22) PCT Filed: Sep. 28, 2021
(86) PCT No.: PCT/JP2021/035503

§ 371 Date: Mar. 8, 2024

(51) Int. Cl. G05B 19/4099

(52) U.S. Cl. CPC G05B 19/4099; G05B 2219/45031

(57) ABSTRACT

A device management system of this disclosure comprises: a parameter reception means for receiving, in a concealed format, a parameter relating to the operation status of a semiconductor manufacturing device, the parameter being used in an analysis relating to indication maintenance of the semiconductor manufacturing device; an indication maintenance analysis means for performing an analysis, by a secret calculation which uses the received parameter in the concealed format and which is related to indication maintenance of a component of the semiconductor manufacturing device; and an output means for outputting the analysis result of the indication maintenance of the component.

### TECHNICAL FIELD

The present disclosure relates to a device management system, an indication maintenance system, a device management method, and a recording medium.

### BACKGROUND ART

A semiconductor manufacturing device manufacturer remotely monitors an operation status of a device delivered to the semiconductor manufacturer, and promptly copes with a defect or a sign of a failure of the semiconductor manufacturing device when detecting the defect or the sign of the failure, thereby preventing a decrease in productivity.

For example, PTL 1 discloses a system that creates a parameter prediction model of a maintenance component based on a value of a meta-parameter included in a life prediction model of the maintenance component of a semiconductor manufacturing device and calculates the predicted life.

### CITATION LIST

### Patent Literature

PTL 1: WO 2012/157040 A1

### SUMMARY OF INVENTION

### Technical Problem

However, in the invention described in PTL 1 described above, since data predicted by a single prediction model is output, there is a limit to improving the accuracy of prediction data. The parameters of the semiconductor manufacturing device monitored for predicting a defect or failure are information to be kept secret for know-how of semiconductor manufacturers. A device manufacturer also has business with a competing semiconductor manufacturer, and thus does not want to receive know-how information.

An object of the present disclosure is to provide a system that analyzes indication maintenance while concealing know-how information held by a semiconductor manufacturer.

### Solution to Problem

A device management system according to an aspect of the present disclosure includes: a parameter reception means configured to receive, in a concealed form, a parameter relating to an operation status of a semiconductor manufacturing device, the parameter being used in an analysis relating to indication maintenance of the semiconductor manufacturing device: an indication maintenance analysis means configured to perform an analysis on indication maintenance of a component of the semiconductor manufacturing device by secure calculation using the received parameter in the concealed form; and an output means configured to output an analysis result of the indication maintenance of the component.

An indication maintenance system according to an aspect of the present disclosure includes: one or more semiconductor manufacturer servers; and a device management system. The one or more semiconductor manufacturer servers each include: a parameter storage unit that stores a parameter related to an operation status of a semiconductor manufacturing device: a concealing unit that conceals a parameter stored in the parameter storage unit; and a parameter input/output unit that transmits a parameter concealed by the concealing unit to a device management system in a concealed form. The device management system includes: a parameter reception means that is used for analysis related to indication maintenance of a semiconductor manufacturing device and receives a parameter related to an operation status of the semiconductor manufacturing device in a concealed form; an indication maintenance analysis means that analyzes indication maintenance of components of a semiconductor manufacturing device by secure calculation using the received parameters in the concealed form; and an output means that outputs a result of indication maintenance of the analyzed component.

A device management method according to an aspect of the present disclosure includes: receiving, in a concealed form, a parameter used for analysis relating to indication maintenance of a semiconductor manufacturing device and relating to an operation status of the semiconductor manufacturing device: analyzing indication maintenance of components of the semiconductor manufacturing device by secure calculation using the received parameter in the concealed form; and outputting a result of indication maintenance of the analyzed component.

A recording medium according to an aspect of the present disclosure stores a program causing a computer to execute: receiving, in a concealed form, a parameter used for analysis relating to indication maintenance of a semiconductor manufacturing device and relating to an operation status of the semiconductor manufacturing device; analyzing indication maintenance of components of a semiconductor manufacturing device by secure calculation using the received parameter in the concealed form; and outputting a result of indication maintenance of the analyzed component.

### Advantageous Effects of Invention

An example of an effect of the present disclosure can provide a system that performs analysis on indication maintenance while keeping know-how information held by a semiconductor manufacturer secret.

### BRIEF DESCRIPTION OF DRAWINGS

FIG. 1 is a block diagram illustrating a configuration of an indication maintenance system according to a first example embodiment.

FIG. 2 is a diagram illustrating a hardware configuration in which a device management system according to the first example embodiment is implemented by a computer device and its peripheral device.

FIG. 3 is a flowchart illustrating an operation of device management according to the first example embodiment.

FIG. 4 is a block diagram illustrating a configuration of an indication maintenance system according to a second example embodiment.

FIG. 5 is a flowchart illustrating an operation of indication maintenance according to the second example embodiment.

### EXAMPLE EMBODIMENT

Next, example embodiments will be described in detail with reference to the drawings.

### First Example Embodiment

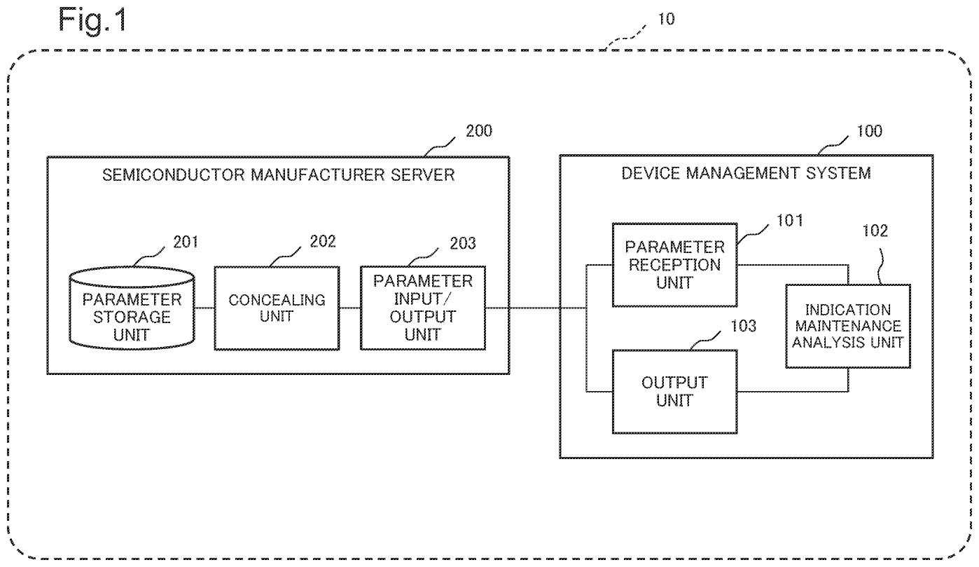

FIG. 1 is a block diagram illustrating a configuration of an indication maintenance system 10 according to a first example embodiment. Referring to FIG. 1, the indication maintenance system 10 includes a device management system 100 of a semiconductor manufacturing device and a semiconductor manufacturer server 200. The device management system 100 is implemented by a service provider who is entrusted with maintenance and repair of the semiconductor manufacturing device.

The device management system 100 of the semiconductor manufacturing device includes a parameter reception unit 101, an indication maintenance analysis unit 102, and an output unit 103. The semiconductor manufacturer server 200 includes a parameter storage unit 201 that stores parameters of the semiconductor manufacturing device, a concealing unit 202 that conceals the parameters, and a parameter input/output unit 203 that inputs and outputs the parameters to and from the device management system 100. The parameter storage unit 201 is connected to each semiconductor manufacturing device in the factory via a network, and stores operating conditions of each manufacturing device, logs relating to process parameters, and the like.

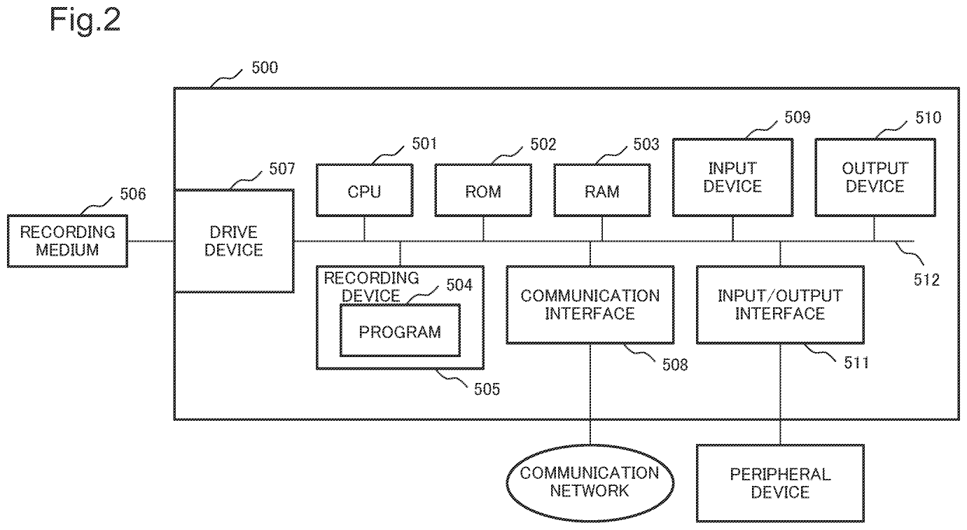

FIG. 2 is a diagram illustrating an example of a hardware configuration in which the device management system 100 of the semiconductor manufacturing device according to the first example embodiment of the present disclosure is achieved by a computer device 500 including a processor. As illustrated in FIG. 2, the device management system 100 includes a memory such as a central processing unit (CPU) 501, a read only memory (ROM) 502, and a random access memory (RAM) 503, a storage device 505 such as a hard disk that stores a program 504, a communication interface (I/F) 508 for network connection, and an input/output interface 511 that inputs and outputs data. In the first example embodiment, the parameter information received from each semiconductor manufacturer server 200 is input to the device management system 100 via the communication I/F 508.

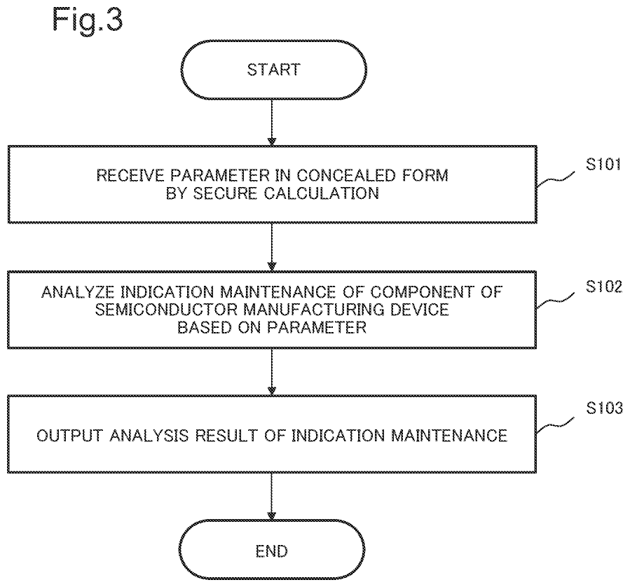

The CPU 501 operates the operating system to control the entire device management system 100 according to the first example embodiment of the present invention. The CPU 501 reads a program and data from a recording medium 506 mounted on, for example, a drive device 507 to a memory. The CPU 501 functions as the parameter reception unit 101, the indication maintenance analysis unit 102, the output unit 103, and a part thereof in the first example embodiment, and executes processing or a command in the flowchart illustrated in FIG. 3 to be described later based on a program.

The recording medium 506 is, for example, an optical disk, a flexible disk, a magnetic optical disk, an external hard disk, a semiconductor memory, or the like. A part of the recording medium of the storage device is a non-volatile storage device, and records a program therein. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to confirm an output.

As described above, the first example embodiment illustrated in FIG. 1 is implemented by the computer hardware illustrated in FIG. 2. However, the means for implementing each unit included in the device management system 100 of FIG. 1 is not limited to the configuration described above. The device management system 100 may be implemented by one physically coupled device, or may be implemented by a plurality of devices by connecting two or more physically separated devices in a wired or wireless manner. For example, the input device 509 and the output device 510 may be connected to the computer device 500 via a network. The device management system 100 according to the first example embodiment illustrated in FIG. 1 can be configured by cloud computing or the like.

In FIG. 1, a parameter reception unit 101 is a means that is used for analysis regarding indication maintenance of a semiconductor manufacturing device and receives a parameter regarding an operation status of the semiconductor manufacturing device in a concealed form. The semiconductor manufacturing device refers to a general device used for manufacturing a semiconductor. Examples of the semiconductor manufacturing device include, for example, a manufacturing device used in an element formation process on a wafer, which is the pre-process of a semiconductor manufacturing process, a diffusion/thermal oxidation device, a film formation related device (including an etching device), a coater/developer device, an exposure device, a cleaning/etching device, or an ion implantation/annealing device. Examples of the film formation related device include plasma CVD (Chemical Vapor Deposition), a dry etching device (RIE), RF plasma, sputtering, and CVD. The indication maintenance means, for example, measuring and monitoring the state of the semiconductor manufacturing device, grasping or indicating the deterioration state of the equipment, and replacing or repairing the components.

The parameter is a parameter relating to an operation status of the semiconductor manufacturing device. More specifically, the parameter is a parameter that changes depending on the operating time of the semiconductor manufacturing device and can predict the necessity of maintenance in a specific unit of the semiconductor manufacturing device. The component used in the semiconductor manufacturing device is, for example, a component that particularly affects the yield and the accuracy of the manufactured semiconductor among components used in the semiconductor manufacturing device. Examples of the component used in the semiconductor manufacturing device include a heating lamp, a light source, an ion source, a turbo molecular pump, a vacuum valve, and a chamber.

The parameter is classified into, for example, a process parameter and an operation status parameter. The process parameter is, for example, a value obtained by measuring a physical quantity in the manufacturing device when the semiconductor manufacturing device is in operation, and is obtained from a sensor value attached to the semiconductor manufacturing device. Examples of the sensor include a current sensor, a temperature sensor, a vibration sensor, and an acceleration sensor. Examples of the process parameter include a consumption current and a vibration degree in a specific unit in the semiconductor manufacturing device. Examples of other process parameters in the film formation related device include a gas flow rate, a film formation time, a substrate temperature, a Vpp voltage and a Vdc voltage (Plasma CVD, dry etching), a DC bias (sputtering), and a pressure. Examples of the process parameters of the semiconductor manufacturing device other than those relating to film formation include the cleaning degree and the etching depth in the cleaning/etching device, for example. Examples of the diffusion/thermal oxidation device include a depth and a thickness of an oxide film, and a sheet resistance. The ion implantation/annealing device is, for example, a profile sheet resistance. The coater/developer is, for example, a resist pattern.

The operation status parameter is a parameter indicating a setting condition during operation of the semiconductor manufacturing device. Examples of the operation status parameters in the film formation related device include input power, a reflected wave→0 (close to 0 of the reflection coefficient), an ultimate vacuum degree in the chamber, and heating lamp power in the plasma CVD. Examples of the dry etching device include an ultimate vacuum degree and heating lamp power. Examples of the RF plasma include incident wave Pf, reflected wave Pr, a value of the variable capacitor, and heating lamp power. Examples of the sputtering device include an input power, a reflected wave, an ultimate vacuum degree, and a heating lamp electrode. The CVD is heating lamp power. The operation status parameter other than the film formation related device is, for example, a degree of vacuum or infrared lamp power as the ion implantation/annealing device. The exposure device is, for example, a light source output. The coater/developer is, for example, acceleration.

The concealed form is, for example, a form concealed using secure calculation. As the secure calculation method, there is special encryption relevant to specific processing such as homomorphic encryption, a trusted execution environment in which processing is performed in a state of being isolated on hardware, or multi-party calculation method in which calculation processing (secure variation calculation) is performed in a state of being securely distributed by a plurality of servers. In a case where the multi-party calculation is used as the secure calculation method, the concealing unit 202 in the semiconductor manufacturer server 200 includes a plurality of servers. According to the secure variation calculation, management of an encryption key and an isolated environment are unnecessary, and calculation processing is faster. In a case where secure variation calculation (multi-party calculation method) is used as the secure calculation method, the parameter reception unit 101 receives parameters in a distributed state.

A specific method of the secure calculation of the multi-party calculation includes the following examples. For example, the concealed data a is distributed securely to the distributed values x, y, . . . , and the administrator transmits x, y, . . . to different servers. Next, the calculation is advanced while performing communication with each other in a state where the concealed data a is distributed securely, and finally the distributed values u, v, . . . of the outputs, which are the calculation results of the servers, are collected and restoration processing is performed, whereby F(a) of the calculation result is obtained. This calculation result is a result of secure calculation regarding indication analysis of components of the semiconductor manufacturing device.

For example, the parameter reception unit 101 receives the stored parameters via the communication I/F 508 through the network in a concealed form in the semiconductor manufacturer server 200 with an operation for analyzing the necessity of maintenance of the components of the semiconductor manufacturing device by the service provider as a trigger. The parameter reception unit 101 outputs the acquired parameters to the indication maintenance analysis unit 102.

The indication maintenance analysis unit 102 is a means that analyzes indication maintenance of components of the semiconductor manufacturing device by secure calculation using the received parameters in the concealed form. The indication maintenance analysis unit 102 estimates the necessity of maintenance of a component correlated with a specific parameter by using the parameter input from the parameter reception unit 101. In the present example embodiment, the component includes a specific unit including a plurality of components in addition to individual components used in the semiconductor manufacturing device. For example, in a case where a target component to be analyzed for indication maintenance is a light source, the indication maintenance analysis unit 102 uses a light source output as a parameter.

For example, the indication maintenance analysis unit 102 analyzes indication maintenance of components based on a parameter defined by a difference from a reference value. Here, the reference value is a preset parameter value, for example, an initial value parameter value when the operation of the semiconductor manufacturing device is started. The indication maintenance analysis unit 102 analyzes indication maintenance of a component based on a difference such as a variation rate from a reference value, and estimates the necessity of maintenance of the component.

The output unit 103 is a means that transmits the analysis result of the indication maintenance of components analyzed by the indication maintenance analysis unit 102 to the semiconductor manufacturer server 200. The output unit 103 transmits the analysis result in such a form that the analysis result of the indication maintenance can be viewed on the semiconductor manufacturer server 200 side. The indication maintenance analysis result indicates necessity of maintenance on a specific component. The output unit 103 may output a list of component names that need to be maintained. The output unit 103 may output, for example, information indicating a replacement time or a time when inspection of the component is required as the additional information.

The operation of the device management system 100 configured as described above will be described with reference to the flowchart of FIG. 3.

FIG. 3 is a flowchart illustrating an outline of an operation of the device management system 100 according to the first example embodiment. The processing according to this flowchart may be executed based on program control by the processor described above.

As illustrated in FIG. 3, first, the parameter reception unit 101 receives parameters in a concealed form from the semiconductor manufacturer server 200 (step S101). Next, the indication maintenance analysis unit 102 analyzes indication maintenance of components of the semiconductor manufacturing device based on the parameters (step S102). Finally, the output unit 103 outputs an analysis result of the indication maintenance by the indication maintenance analysis unit 102 (step S103). As described above, the device management system 100 of the semiconductor manufacturing device ends the device management operation.

In the device management system 100 of the semiconductor manufacturing device, the indication maintenance analysis unit 102 analyzes indication maintenance of components of the semiconductor manufacturing device based on the concealed parameters. As a result, it is possible to provide a system that analyzes indication maintenance while concealing parameter information as know-how held by a semiconductor manufacturer.

### Second Example Embodiment

Next, a second example embodiment of the present disclosure will be described in detail with reference to the drawings. Hereinafter, description of contents overlapping with the above description will be omitted to the extent that the description of the present example embodiment is not unclear. An indication maintenance system 11 according to the second example embodiment is used to provide a system that makes arrangements necessary for indication maintenance based on components having a service life analyzed by an indication maintenance analysis unit. Similarly to the computer device illustrated in FIG. 2, each component in each example embodiment of the present disclosure can be achieved not only by hardware but also by a computer device or firmware based on program control.

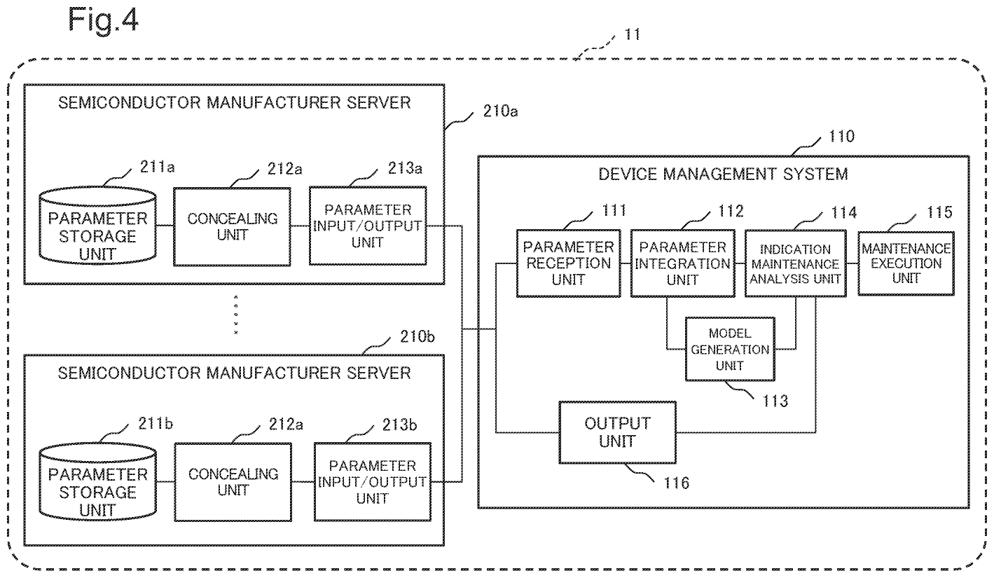

FIG. 4 is a block diagram illustrating a configuration of the indication maintenance system 11 including a device management system 110 according to the second example embodiment of the present disclosure. With reference to FIG. 4, the device management system 110 and a semiconductor manufacturer server 210 (210a, 210b) according to the second example embodiment will be described focusing on portions different from the indication maintenance system 10 according to the first example embodiment. The device management system 110 according to the second example embodiment includes a parameter reception unit 111, a parameter integration unit 112, a model generation unit 113, an indication maintenance analysis unit 114, a maintenance execution unit 115, and an output unit 116. The plurality of semiconductor manufacturer servers 210 (210a, 210b) includes a parameter storage unit 211 (211a, 211b) and a concealing unit 212 (212a, 212b), and a parameter input/output unit 213 (213a, 213b).

The device management system 100 according to the first example embodiment receives the parameter indicating the operation status of the semiconductor manufacturing device in a concealed form using secure calculation from the single semiconductor manufacturer server 200. On the other hand, the device management system 110 integrates the parameters relating to the operation status of the same type of semiconductor manufacturing device from the plurality of servers 210a and 210b by secure calculation. The parameter relating to the operation status of the same type of semiconductor manufacturing device is, for example, a parameter indicating a correlation similar to that of a specific component in the same type of semiconductor manufacturing device.

The plurality of semiconductor manufacturer servers 210 are servers owned by a plurality of customers (for example, a competing semiconductor manufacturer) of semiconductor manufacturing device manufacturers. In this case, the parameters of the conflicts can be analyzed together while being concealed. Another example of the plurality of semiconductor manufacturer servers 210 is a case where parameters are stored in different servers for each lot even in the same factory. In the present example embodiment, the plurality of semiconductor manufacturer servers 200 are provided at two locations, but the present invention is not limited thereto. The plurality of semiconductor manufacturer servers 200 are provided as many as the number of parameters to be integrated. Hereinafter, the device management system 110 of the semiconductor manufacturing device according to the present example embodiment will be described in detail. The parameter reception unit 111 and the output unit 116 have the same configuration and function as the parameter reception unit 101 and the output unit 103 in the first example embodiment, respectively, and thus, description thereof is omitted here.

### <Device Management System>

The parameter integration unit 112 is a means that integrates the plurality of received parameters by secure calculation in a case where the same type of parameters are received from the plurality of servers. In the present example embodiment, integration by secure calculation means that the parameter reception unit 111 collectively performs calculation processing on the parameters in the concealed form received from each semiconductor manufacturer server 210 in the concealed state. The parameter integration unit 112 outputs the integrated parameters to the indication maintenance analysis unit 114.

The model generation unit 113 generates a model for estimating the necessity of maintenance of components of the semiconductor manufacturing device based on the relationship between the parameters acquired in the past and the necessity of maintenance. More specifically, the model generation unit 113 generates a model in which information indicating the necessity of maintenance of a component in the semiconductor manufacturing device is set as an objective variable, and information on a parameter of the semiconductor manufacturing device is set as an explanatory variable. The model generation unit 113 stores the generated model in the storage device 505.

The indication maintenance analysis unit 114 analyzes indication maintenance of components of the semiconductor manufacturing device using the model generated by the model generation unit 113. When the indication maintenance analysis unit 114 inputs the parameter integrated in the parameter integration unit 112 to a model stored in the storage device 505, for example, information on a component correlated with the parameter and necessity of maintenance of the component is output. The indication maintenance analysis unit 114 outputs the output information on necessity of maintenance of the component to the maintenance execution unit 115 and the output unit 116.

The maintenance execution unit 115 is a means that performs an arrangement necessary for maintenance of components of the semiconductor manufacturing device based on an analysis result of the indication maintenance by the indication maintenance analysis unit 114. When information indicating that maintenance is necessary is input from the indication maintenance analysis unit 114, the maintenance execution unit 115 makes an arrangement necessary for maintenance of components. The arrangement necessary for maintenance is, for example, an order for components in the case of component replacement. In a case where the arrangement necessary for maintenance is to repair a component, the arrangement is to arrange a maintenance worker to repair the component. When information indicating that maintenance is unnecessary is input from the indication maintenance analysis unit 114, the maintenance execution unit 115 notifies the semiconductor manufacturer server 210 of the information. In this case, the semiconductor manufacturer server 210 repeats a series of operations after a certain period of time (for example, one month later).

### <Semiconductor Manufacturer Server>

The semiconductor manufacturer server 210 includes a parameter storage unit 211, a concealing unit 212, and a parameter input/output unit 213. The parameter storage unit 211 stores, for example, parameters acquired from the semiconductor manufacturing device for each acquisition time. The acquisition time is an acquisition date and time, a lot number, and the like. The concealing unit 212 conceals the parameters stored in the parameter storage unit 211 using secure calculation. The concealing unit 212 may use only a specific parameter among the parameters stored in the parameter storage unit 211, or may use an average value of a plurality of parameters. The parameter input/output unit 213 transmits the concealed parameters to the device management system 110 in a concealed form.

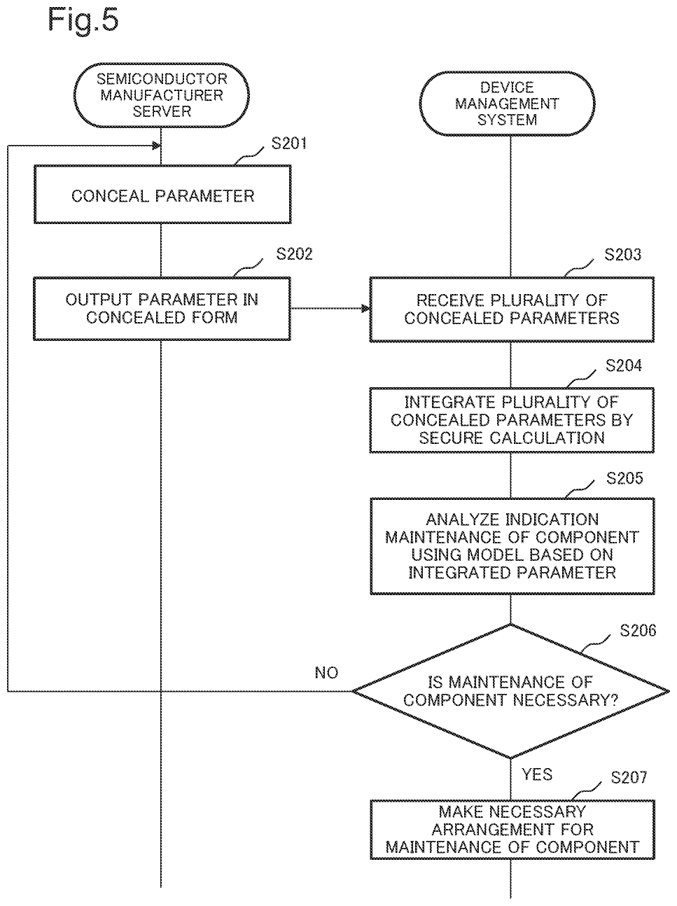

The operation of the indication maintenance system 11 configured as described above will be described with reference to the flowchart of FIG. 5.

FIG. 5 is a flowchart illustrating an outline of the operation of the indication maintenance system 11 according to the second example embodiment. The processing according to this flowchart may be executed based on program control by the processor described above.

As illustrated in FIG. 5, first, the concealing unit 212 of the semiconductor manufacturer server 210 conceals the parameters stored in the parameter storage unit 211 (step S201). Next, the parameter input/output unit 213 outputs the parameter to the device management system 110 in a concealed form (step S202). Next, the parameter reception unit 111 of the device management system 110 receives the plurality of concealed parameters (step S203). Next, the parameter integration unit 112 integrates the parameters of the plurality of concealed semiconductor manufacturing devices by secure calculation in a concealed form (step S204). Next, the indication maintenance analysis unit 114 analyzes indication maintenance of components of the semiconductor manufacturing device using the model generated by the model generation unit 113 based on the integrated parameters (step S205). Next, as a result of the indication analysis, in a case where it is determined that the maintenance of the component is necessary (step S206: YES), the maintenance execution unit 115 makes an arrangement necessary for maintenance of the component (step S207). On the other hand, as a result of the indication analysis, in a case where it is determined that the maintenance of the component is not necessary (step S206: NO), the information is notified to the semiconductor manufacturer server 210, and a series of operations is repeated. As described above, the indication maintenance system 11 ends the indication maintenance operation.

In the second example embodiment of the present disclosure, in a case where it is determined that the maintenance of the component is necessary as a result of the indication analysis by the indication maintenance analysis unit 114, the maintenance execution unit 115 makes an arrangement necessary for the maintenance of the component. As a result, when the maintenance of the component is necessary, the semiconductor manufacturer can perform the indication maintenance of the component without arranging the maintenance. In the second example embodiment of the present disclosure, the parameter integration unit 112 integrates the plurality of concealed parameters by secure calculation in a concealed form. As described above, by integrating the parameters acquired from the plurality of semiconductor manufacturer servers, the analysis accuracy regarding the maintenance of the component can be enhanced.

Although the present invention has been described with reference to each example embodiment, the present invention is not limited to the above example embodiments. Various modifications that can be understood by those of ordinary skill in the art can be made to the configuration and details of the present invention within the scope of the present invention.

For example, although the plurality of operations are described in order in the form of a flowchart, the order of description does not limit the order of executing the plurality of operations. Therefore, when each example embodiment is implemented, the order of the plurality of operations can be changed within a range that does not interfere with the content.

In the present example embodiment, when the indication maintenance analysis unit 114 inputs a specific parameter of the semiconductor manufacturing device to the model generated by the model generation unit 113, information regarding a component correlated with the parameter and necessity of maintenance of the component is output. However, in the present example embodiment, when the indication maintenance analysis unit 114 inputs a specific parameter of the semiconductor manufacturing device to the model generated by the model generation unit 113, a component correlated with the parameter, the time required to maintain the component, the life of the component, and the like may be output. In this case, the model generated by the model generation unit 113 is a model that outputs a prediction value of information indicating the time when maintenance of a component of the semiconductor manufacturing device is necessary and the life of the component when a parameter of the semiconductor manufacturing device is input. In this case, for example, the necessity of maintenance can be determined based on a desired determination criterion.

Some or all of the above example embodiments may be described as the following Supplementary Notes, but are not limited to the following.

### Supplementary Note 1

A device management system including:
a parameter reception means configured to receive, in a concealed form, a parameter relating to an operation status of a semiconductor manufacturing device, the parameter being used in an analysis relating to indication maintenance of the semiconductor manufacturing device:
an indication maintenance analysis means configured to perform an analysis, by a secure calculation which uses the received parameter in the concealed form and which is related to indication maintenance of a component of the semiconductor manufacturing device; and
an output means configured to output an analysis result of the indication maintenance of the component.

### Supplementary Note 2

The device management system according to Supplementary Note 1, further including:
a parameter integration means configured to integrate the plurality of parameters received by the parameter reception means by secure calculation in a concealed form in a case where the same type of parameters are received from the plurality of servers, in which
the indication maintenance analysis means analyzes indication maintenance of components of a semiconductor manufacturing device using the parameters integrated by the parameter integration means.

### Supplementary Note 3

The device management system according to Supplementary Note 2, in which each of the plurality of servers is a server owned by a different semiconductor manufacturer.

### Supplementary Note 4

The device management system according to any one of Supplementary Notes 1 to 3, in which the parameter is a parameter defined by a difference from a reference value.

### Supplementary Note 5

The device management system according to any one of Supplementary Notes 1 to 4, in which the parameter is a parameter related to an operation status of a film formation related device.

### Supplementary Note 6

The device management system according to any one of Supplementary Notes 1 to 5, in which the indication maintenance analysis means analyzes indication maintenance of components of the semiconductor manufacturing device by using a learned model.

### Supplementary Note 7

The device management system according to Supplementary Note 6, in which the learned model is a model that inputs the parameter and outputs necessity of maintenance of a component in the semiconductor manufacturing device.

### Supplementary Note 8

The device management system according to Supplementary Note 6 or 7, further including:
a model generation means configured to generate the learned model, in which
the learned model generates a model for estimating necessity of maintenance of a component of the semiconductor manufacturing device based on a relationship between a parameter acquired in a past and necessity of maintenance.

### Supplementary Note 9

The device management system according to any one of Supplementary Notes 1 to 8, in which the secure calculation is a secure variation calculation.

### Supplementary Note 10

The device management system according to any one of Supplementary Notes 1 to 9, further including:
a maintenance execution means configured to make an arrangement related to maintenance of the component based on a result analyzed by the indication maintenance analysis means.

### Supplementary Note 11

The device management system according to claim 10, in which the maintenance execution means orders necessary components in the semiconductor manufacturing device.

### Supplementary Note 12

An indication maintenance system including:
one or more semiconductor manufacturer servers; and
a device management system, in which
the one or more semiconductor manufacturer servers each include:
a parameter storage unit that stores a parameter related to an operation status of a semiconductor manufacturing device;
a concealing unit that conceals a parameter stored in the parameter storage unit; and
a parameter input/output unit that transmits a parameter concealed by the concealing unit to a device management system in a concealed form, and
the device management system includes:
a parameter reception means that is used for analysis related to indication maintenance of a semiconductor manufacturing device and receives a parameter related to an operation status of the semiconductor manufacturing device in a concealed form;
an indication maintenance analysis means that analyzes indication maintenance of components of a semiconductor manufacturing device by secure calculation using the received parameters in the concealed form; and
an output means that outputs a result of indication maintenance of the analyzed component.

### Supplementary Note 13

A device management method including:
receiving, in a concealed form, a parameter used for analysis relating to indication maintenance of a semiconductor manufacturing device and relating to an operation status of the semiconductor manufacturing device;
analyzing indication maintenance of components of the semiconductor manufacturing device by secure calculation using the received parameter in the concealed form; and
outputting a result of indication maintenance of the analyzed component.

### Supplementary Note 14

A recording medium for storing a program causing a computer to execute:
receiving, in a concealed form, a parameter used for analysis relating to indication maintenance of a semiconductor manufacturing device and relating to an operation status of the semiconductor manufacturing device;
analyzing indication maintenance of components of a semiconductor manufacturing device by secure calculation using the received parameter in the concealed form; and
outputting a result of indication maintenance of the analyzed component.

### REFERENCE SIGNS LIST

10, 11 indication maintenance system
100, 110 device management system
101, 111 parameter reception unit
102, 114 indication maintenance analysis unit
103, 116 output unit
112 parameter integration unit
113 model generation unit
115 maintenance execution unit
200, 210 semiconductor manufacturer server
201, 211 parameter storage unit
202, 212 concealing unit
203, 213 parameter input/output unit

What is claimed is:

1. A device management system comprising:
a memory storing instructions; and
at least one processor configured to execute the instructions to:
receive, in a concealed form, a parameter relating to an operation status of a semiconductor manufacturing device, wherein the parameter is used in an analysis relating to indication maintenance of the semiconductor manufacturing device;
perform an analysis, by a secure calculation which uses the received parameter in the concealed form and which is relating to indication maintenance of a component of the semiconductor manufacturing device; and
output an analysis result of the indication maintenance of the component.

2. The device management system according to claim 1, wherein the at least one processor is further configured to execute the instructions to:
integrate the plurality of parameters received by secure calculation in a concealed form in a case where the same type of parameters are received from the plurality of servers; and
analyze indication maintenance of components of a semiconductor manufacturing device using the parameters integrated.

3. The device management system according to claim 2, wherein each of the plurality of servers is a server owned by a different semiconductor manufacturer.

4. The device management system according to claim 1, wherein the parameter is a parameter defined by a difference from a reference value.

5. The device management system according to claim 1, wherein the parameter is a parameter relating to an operation status of a film formation related device.

6. The device management system according to claim 1, wherein the at least one processor is further configured to execute the instructions to: analyze indication maintenance of components of the semiconductor manufacturing device by using a learned model.

7. The device management system according to claim 6, wherein the learned model is a model that inputs the parameter and outputs necessity of maintenance of a component in the semiconductor manufacturing device.

8. The device management system according to claim 6, wherein the at least one processor is further configured to execute the instructions to:
generate a model for estimating necessity of maintenance of a component of the semiconductor manufacturing device based on a relationship between a parameter acquired in a past and necessity of maintenance.

9. The device management system according to claim 1, wherein the secure calculation is a secure variation calculation.

10. The device management system according to claim 1, wherein the at least one processor is further configured to execute the instructions to:
make an arrangement relating to maintenance of the component based on a result analyzed.

11. The device management system according to claim 10, wherein the at least one processor is further configured to execute the instructions to:
order necessary components in the semiconductor manufacturing device.

12. An indication maintenance system includes:
one or more semiconductor manufacturer servers; and
a device management system, wherein
the one or more semiconductor manufacturer servers each comprising:
a memory storing instructions; and
at least one processor configured to execute the instructions to:
store a parameter relating to an operation status of a semiconductor manufacturing device;
conceal a parameter stored; and
transmit a parameter concealed to a device management system in a concealed form, and
the device management system comprising:
a memory storing instructions; and
at least one processor configured to execute the instructions to:
receive a parameter relating to an operation status of the semiconductor manufacturing device in a concealed form, wherein the parameter is used for analysis relating to indication maintenance of a semiconductor manufacturing device;
analyze indication maintenance of components of a semiconductor manufacturing device by secure calculation using the received parameters in the concealed form; and
output a result of indication maintenance of the analyzed component.

13. A device management method comprising:
receiving, in a concealed form, a parameter used for analysis relating to indication maintenance of a semiconductor manufacturing device and relating to an operation status of the semiconductor manufacturing device;
analyzing indication maintenance of components of the semiconductor manufacturing device by secure calculation using the received parameter in the concealed form; and
outputting a result of indication maintenance of the analyzed component.

14. A non-transitory recording medium for storing a program causing a computer to execute:
receiving, in a concealed form, a parameter used for analysis relating to indication maintenance of a semiconductor manufacturing device and relating to an operation status of the semiconductor manufacturing device;
analyzing indication maintenance of components of a semiconductor manufacturing device by secure calculation using the received parameter in the concealed form; and
outputting a result of indication maintenance of the analyzed component.
